(19) United States
(12) Patent Application Publication
(10) Pub. No.: US 2015/0378101 A1
(43) Pub. Date: Dec. 31, 2015

(54) METHODS OF OPTICAL PATHWAY DEVICE CONSTRUCTION

(71) Applicant: Dan Vance, San Diego, CA (US)

(72) Inventor: Dan Vance, San Diego, CA (US)

(21) Appl. No.: 14/751,211

(22) Filed: Jun. 26, 2015

Related U.S. Application Data
(60) Provisional application No. 61/998,400, filed on Jun. 27, 2014.

(51) Int. Cl. G02B 6/132; G02B 6/138; G02B 1/12

(52) U.S. Cl. CPC G02B 6/132; G02B 1/12; G02B 6/138

(57) ABSTRACT

Disclosed are devices, systems, and methods for construction or fabrication of optical fiber-like devices by depositing curable optical materials of differing indices of refraction in a controlled manner forming integral optical pathways, the integral optical pathways exhibiting total internal reflection and functioning essentially equivalent optical properties to conventional optical fibers optical pathways.

### CROSS-REFERENCE TO RELATED APPLICATIONS

This application claims the benefit of U.S. Provisional Application No. 61/998,400, filed Jun. 27, 2014, which is incorporated herein by reference.

### FIELD

The present invention is generally related to construction or fabrication of optical devices, and more particularly, the present invention discloses methods of constructing or fabricating optical pathways as integral parts of a device structure that has essentially equivalent optical properties to conventional optical fibers.

### BACKGROUND

In the field of optics and especially optical imaging, a number of devices are found, including, but not limited to, Fiber Optic Faceplates and Fiber Optic Tapers, that are historically constructed by combining a plurality of discrete optical fibers. Optical fibers are typically cylindrical strands of glass or optical polymer with an index of refraction of n₁, sheathed or clad with a thin layer of a second glass or polymer with an index of refraction of n₂, where n₂ is less than n₁, thereby enabling the well-known phenomenon of Total Internal Reflection.

Fiber Optic Taper and Fiber Optic Faceplates are currently and typically constructed as follows:
1. A usually large number of discrete optical fibers are gathered into a bundle (usually round) and heated to the softening point of the cladding material while circumferential pressure is applied to the bundle, causing the fibers to fuse together.
   a. In the case of a fiber optic faceplate, the fused bundle is then sliced into disks of desired thickness.
      i. The faces of the disks are ground and polished and the faceplate is trimmed to the desired final size and shape.
   b. In the case of a fiber optic taper, the bundle is heated to the softening point of the material and the bundle is longitudinally stretched so that the diameter necks down between the ends.
      i. The tapered shape is then sliced at the neck and the ends, creating two fiber optic tapers.
   c. As with the fiber optic faceplate, the ends are then ground and polished.

Thus it is seen that the current process requires potentially expensive and complex equipment to handle large bundles of thin, fragile fibers, provide controlled high-temperature compression and drawing, and perform slicing operations.

In view of this, it would be desirable to develop a method or methods of constructing or fabricating optical pathways as integral parts of a device structure, and that the optical pathways have equivalent optical properties to conventional optical fibers.

### SUMMARY

The current Invention is a dramatic and innovative improvement to the methods of construction and fabrication of fiber optic devices in the current art.

In one aspect, the invention is a method of fabricating an optical fiber-like device by depositing curable optical materials of differing indices of refraction in a controlled manner forming integral optical pathways, the pathways exhibiting total internal reflection and functioning as optical fibers.

In many embodiments, depositing curable optical materials in a controlled manner includes depositing multiple layers of discrete deposits of first and second curable optical materials between a bottom surface or face and a top surface or face forming integral optical pathways of the first material surrounded by the second material, the second material having a lower index of refraction than the first material.

In many embodiments, depositing multiple layers of discrete deposits of first and second curable optical materials includes depositing the first and second materials on the corresponding first and second material deposits of the previous layer.

In many embodiments, depositing multiple layers of discrete deposits of first and second curable optical materials includes curing each layer of first and second materials prior to depositing a subsequent layer.

In many embodiments, curing each layer of first and second materials includes exposure to UV light.

In many embodiments, depositing multiple layers of discrete deposits of first and second curable optical materials includes depositing the first and second materials using first and second dispensing heads.

In many embodiments, the first and second dispensing heads are the same head.

In many embodiments, the first and second dispensing heads are computer controlled.

In many embodiments, the device is tapered between the bottom and top surfaces or faces by reducing each subsequent layer in area and material deposit size at a rate of taper desired.

In many embodiments, the first and second materials are selected from the group consisting of polymer resins, acrylics(methacrylate), polycarbonates, epoxies, polyesters and urethanes.

In another aspect, the invention is a method of fabricating an optical fiber-like device by depositing multiple layers of curable optical materials of differing indices of refraction in a controlled manner on a polished surface of a substrate by:

creating a first layer of curable optical materials on the substrate by:
depositing an array pattern of discrete deposits of a first curable liquid optical material on the substrate using one or more first dispensing heads;
curing the first material;
depositing a second curable liquid optical material all the areas surrounding the discrete deposits of the first material on the substrate using one or more second dispensing heads, the second material having a lower index of refraction than the first material;
curing the second material;

creating subsequent layers of curable optical materials by:
depositing discrete deposits of a first curable liquid optical material on the discrete deposits of the previous layer using one or more first dispensing heads;
curing the first material;
depositing a second curable liquid optical material all the areas surrounding the discrete deposits of the first material using one or more second dispensing heads;
curing the second material; and

repeating the creating subsequent layers of the first and second materials on the previous layer until a desired thickness of the fiber optic device is reached, the last layer creating a top surface or face and the layers of discrete deposits forming integral optical pathways of the first material surrounded by the second material between the substrate and top surface or face.

In many embodiments, curing the first and second materials include exposure of the first and second materials to UV light.

In many embodiments, the first and second materials are selected from the group consisting of polymer resins, acrylics(methacrylate), polycarbonates, epoxies, polyesters and urethanes.

In many embodiments, the device is tapered between the substrate and top surface or face by reducing each subsequent layer in area and material deposit size at a rate of taper desired.

In many embodiments, the top surface or face is polished.

In another aspect, the invention is a method of fabricating an optical fiber-like device by depositing multiple layers of curable optical materials of differing indices of refraction in a controlled manner on a polished surface of a substrate by:

creating an initial layer of curable optical material on the substrate by:
depositing an area of second material using one or more second dispensing heads that is equal to the size and shape of a cross-section of the desired optical fiber-like device, perpendicular to desired end faces of the device;
curing the second material;

creating a first layer of curable optical materials on the substrate by:
depositing multiple lines or columns of a first curable liquid optical material on the substrate using one or more first dispensing heads;
curing the first material;
depositing a second curable liquid optical material all the areas surrounding the line or column of the first material on the substrate using one or more second dispensing heads, the second material having a lower index of refraction than the first material;
curing the second material;

creating subsequent layers of curable optical materials by:
depositing multiple lines or columns a first curable liquid optical material on the previous layer using one or more first dispensing heads;
curing the first material;
depositing a second curable liquid optical material all the areas surrounding the lines or columns of the first material using one or more second dispensing heads;
curing the second material; and

repeating the creating subsequent layers of the first and second materials on the previous layer until a desired final height of the fiber optic device is reached, the line or columns of first materials forming integral optical pathways of the first material surrounded by the second material between the end faces.

In many embodiments, curing the first and second materials include exposure of the first and second materials to UV light.

In many embodiments, the first and second materials are selected from the group consisting of polymer resins, acrylics(methacrylate), polycarbonates, epoxies, polyesters and urethanes.

In many embodiments, the device is tapered between the end faces by reducing the cross sectional area of each column of first material to reduce over its length from a large surface or face to a small surface or face.

In many embodiments, an initial construct is created upon the substrate using one or more second dispensing heads dispensing the second material in a size and shape of which corresponds to the size and shape of one outer surface of the desired taper in a chosen plane.

### BRIEF DESCRIPTION OF THE DRAWINGS

FIGS. 1A-1H show one embodiment of fabricating a fiber optic faceplate.

FIGS. 2A-2H show another embodiment of fabricating a fiber optic faceplate.

FIGS. 3A-3J show one embodiment of fabricating a Fiber Optic Taper.

FIGS. 4A-4L show another embodiment of fabricating a Fiber Optic Taper.

### DETAILED DESCRIPTION

Embodiments of the invention will now be described with reference to the figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The disclosed invention is an innovative method of constructing or fabricating integral optical pathways of optical devices, in contrast to the prior art optical devices that are made up of a multiplicity of discrete optical fibers. The disclosed methods allow construction of optical pathways as integral parts of the optical devices. This allows construction or fabrication of optical devices with optical pathways having essentially equivalent optical properties to conventional optical fibers at a much lower cost.

While the invention is disclosed in relation to fiber optic faceplates and fiber optic tapers, it can readily be seen that the methods of construction or fabrication described herein are not limited to fiber optic faceplates and fiber optic tapers. Indeed, practically any device historically constructed using conventional optical fibers can be constructed more efficiently and more cost effectively using the methods of the disclosed invention. Additionally, using the methods of the disclosed invention, devices can now be constructed that would have been impossible or impractical using conventional optical fibers. An example of this is a device wherein a bend or curve is desired that is of too small of a radius for an optical fiber, but such limitation does not exist for a line or shape dispensed as a liquid and then cured.

A fiber optic faceplate is a coherent multi-fiber plate, which acts as a zero-depth window, transferring an image pixel by pixel (fiber by fiber) from one face of the plate to the other. Faceplates are often found in high-end imaging applications bonded to CCD's, voltage stand-off devices in electron microscopes and cathode ray tubes, and as substrates for phosphors. In some embodiments, the fiber optic faceplate can be as large as 355 mm (14″) square or as small as a few hundred microns across, with depth ranging from more than 100 mm down to 50-100 μm.

Fiber Optic Faceplate, Method 1

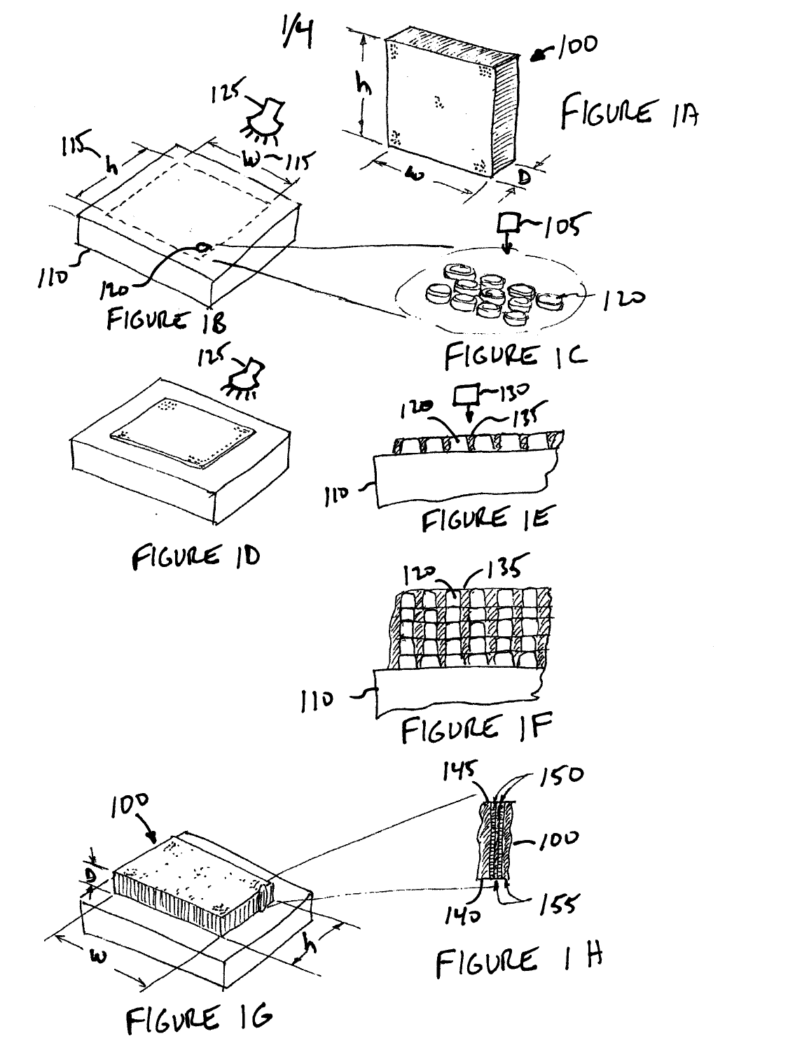

FIG. 1A shows one embodiment of a fiber optic faceplate 100 having a height H, width W and depth D. FIGS. 1B-1H show one embodiment of fabricating the fiber optic faceplate 100. To create a fiber optic faceplate, a dispensing head is configured to dispense a curable liquid optical material of known index of refraction (“n₁”) upon a substrate 110 having a polished surface. A second dispensing head is configured to dispense a curable liquid optical material of a lower index of refraction (“n₂”) than the first material in all the areas surrounding the deposits of n₁ material. The dispensing heads are able to be controllably maneuvered in the x, y and z axes by well-known and conventional means, such as through the use of computer-controlled stepper motors, with dispensing rates similarly controllable. The curable liquid optical material may be any material that can be dispensed from a dispensing heads and cured, such as polymer resins, acrylics(methacrylate), polycarbonates, epoxies, polyesters and urethanes.

The process is described below.

1. FIGS. 1B-1C show one or more first dispensing heads 105 dispensing upon a polished substrate surface of substrate 110 a pattern 115 (H×W) of discrete deposits of n₁ material 120 of the number and size(s) desired for the particular faceplate. The number, size and spacing of the deposits n₁ correspond to the number, size and spacing of optical fibers in an equivalent faceplate of traditional optical fiber construction. The deposits n₁ are then cured, such as by exposure to UV light 125.

2. FIGS. 1D-1E show one or more second dispensing heads 130 dispense n₂ material 135 in all the areas surrounding the deposits of n₁ material 120, within the established perimeter of the face of the faceplate, dispensed by the first dispensing heads in step 1. The n₂ material 135 is then cured, such as by exposure to UV light 125. FIG. 1E shows one layer of n₁ material 120 and n₂ material 135.

3. The process now repeats, layering upon the previous layers, with the next layer of n₁ material deposits and n₂ material fill directly on top of the previous layer. FIG. 1F shows five layers of n₁ material 120 and n₂ material 135.

4. The process is repeated until the desired final thickness D of the faceplate is reached, shown in FIGS. 1G and 1H. The completed faceplate 100 is then removed from the substrate 110. No polishing is needed on the surface or face 140 that was against the polished substrate surface of the substrate 110. Little or no polishing is needed on the top surface or face 145. No cutting of the outer size or shape (w or d) is necessary.

The result is an array of columns or integral optical pathways 150 of n₁ material surrounded by columns 155 of n₂ material. The integral optical pathways or ‘columns’ of n₁ material act the same as ‘fibers’ do in a conventional fiber optic faceplate. The columns 150 are in fact integrally-created fibers now ‘clad’ in n₂ material. The faceplate is simply ‘printed’ as described and is ready to use.

It can readily be seen that the method described herein is not restricted to square or rectangular face shapes. Fiber optic faceplates of practically any face shape, including circular, elliptical, rectangular and square, can be created.

Fiber Optic Faceplate, Method 2

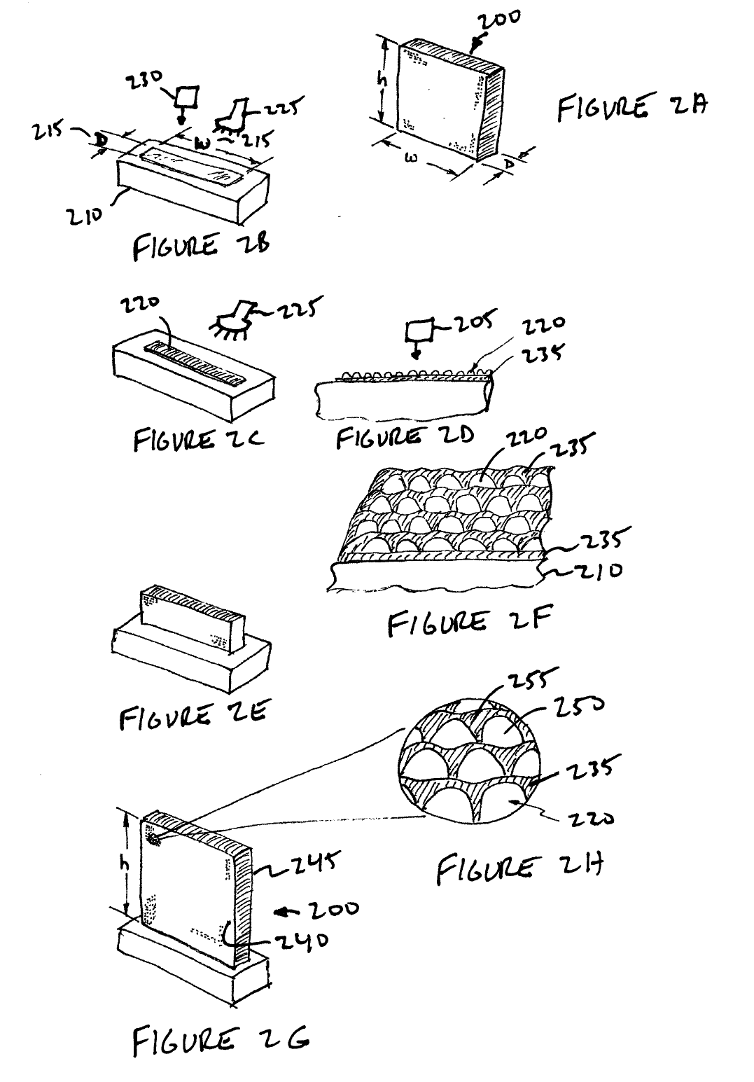

FIG. 2A shows another embodiment of a fiber optic faceplate 200 having a height H, width W and depth D. FIGS. 2B-2H show one embodiment of fabricating the fiber optic faceplate 200. To create a fiber optic faceplate, one or more dispensing heads are configured to dispense curable liquid optical materials, such as a polymer resins, acrylics(methacrylate), polycarbonates, epoxies, polyesters and urethanes, upon a substrate having a polished surface. A first dispensing head 205 is configured to dispense a first curable liquid optical material of known index of refraction (“n₁”) upon the polished surface and a second dispensing head 230 is configured to dispense a second curable liquid optical material, such as a polymer resins, acrylics(methacrylate), polycarbonates, epoxies, polyesters and urethanes, having a lower index of refraction (“n₂”) than the first material in all the areas surrounding the deposits of n₁ material. The dispensing heads are able to be controllably maneuvered in the x, y and z axes by well-known and conventional means, such as through the use of computer-controlled stepper motors, with dispensing rates similarly controllable.

The process is described below.
1. FIG. 2B shows one or more second dispensing heads 230 dispensing an initial thin layer of n₂ material 235 upon the polished substrate 210, covering an area 215 (D×W) that is equal to the size and shape of the cross-section, perpendicular to the faces, of the desired faceplate. This layer is then cured, such as by exposure to UV light 225.
2. FIGS. 2C-2D show one or more first dispensing heads 205 dispensing a line or column 250 of n₁ material 220 upon the cured layer of n₂ material 235, perpendicular to the long dimension of the faceplate cross-section, and of a width and at a spacing equal to the width and spacing of the fibers in a conventional faceplate of the same size. This material is then cured, such as by exposure to UV light 225. FIG. 2D shows one layer of n₁ material 220 upon the n₂ material 235.
3. More n₂ material 235 is then dispensed between and over the n₁ material 220 lines created in step 2. This material is then cured.
4. The process now repeats, layering upon the previous layers. FIGS. 2E and 2F show four layers of n₁ material 220 and n₂ material 235.
5. The process is repeated until the desired final height h of the faceplate is reached, shown in FIGS. 2G and 2H.
6. A thin layer of n₂ material 235 is dispensed as the final layer and cured.
7. The completed faceplate 200 is then removed from the substrate 210. Depending upon the application and level of optical quality desired, the faces 240, 245 of the completed faceplate may be optimized by grinding or sanding, and polishing.

The result is an array of columns or integral optical pathways 250 of n₁ material surrounded by columns 255 of n₂ material. The integral optical pathways or ‘columns’ act as the ‘fibers’ do in a conventional fiber optic faceplate. The columns are in fact integrally-created fibers now ‘clad’ in n₂ material. The faceplate is simply ‘printed’ as described and is ready to use.

It can readily be seen that the method described herein is not restricted to square or rectangular face shapes. Fiber optic faceplates of practically any face shape, including circular, elliptical, rectangular and square, can be created.

Fiber Optic Taper, Method 1

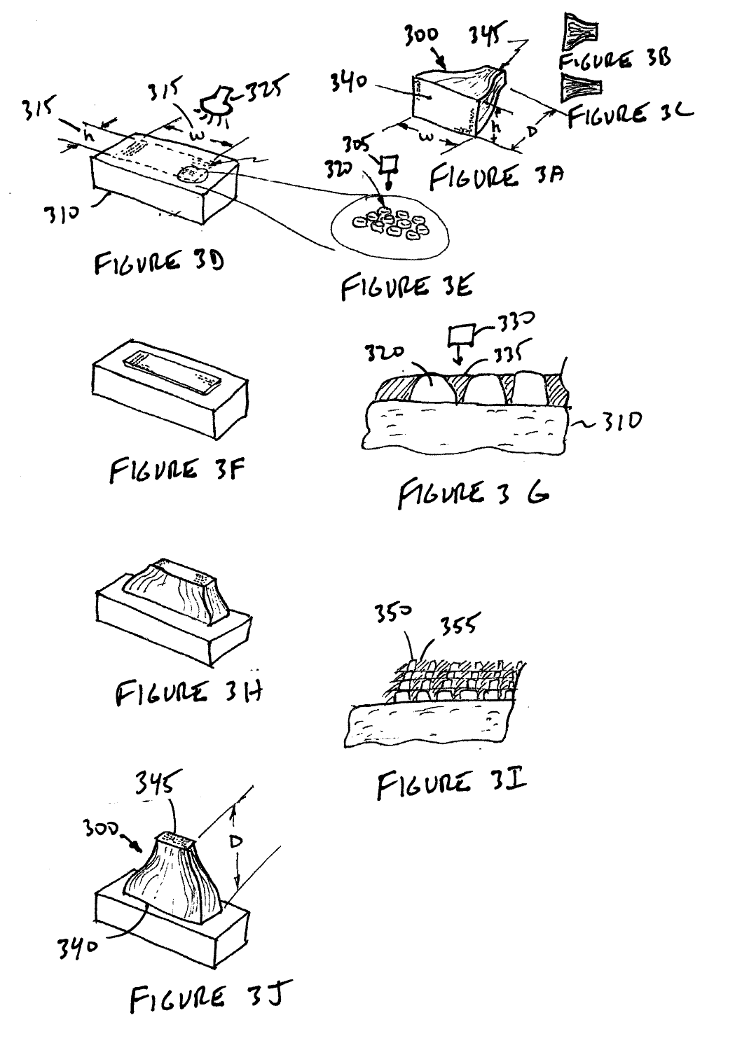

FIGS. 3A-3J show one embodiment of fabricating a Fiber Optic Taper 300 that offers a low-distortion method of magnifying or reducing an image for image transfer applications. The Fiber Optic Taper 300 has a shape with a large end and small end that transmits the image from its input surface or face to its output surface or face, shown in FIGS. 3A-3C. To create a Fiber Optic Taper, one or more dispensing heads are configured to dispense curable liquid optical materials, such as polymer resins, acrylics(methacrylate), polycarbonates, epoxies, polyesters and urethanes, upon a substrate 310 having a polished surface. A first dispensing head 305 is configured to dispense a first curable liquid optical material of known index of refraction (“n₁”) upon the polished surface and a second dispensing head 330 is configured to dispense a second curable liquid optical material, such as a polymer resins, acrylics(methacrylate), polycarbonates, epoxies, polyesters and urethanes, having a lower index of refraction (“n₂”) than the first material in all the areas surrounding the deposits of n₁ material. The dispensing heads are able to be controllably maneuvered in the x, y and z axes by well-known and conventional means, such as through the use of computer-controlled stepper motors, with dispensing rates similarly controllable.

The fiber optic taper 300 is created using the dispensing arrangement previously described above, as follows:
1. FIGS. 3D and 3E show one or more first dispensing heads 305 dispensing upon a polished substrate surface of substrate 310 a pattern 315 (H×W) of discrete deposits of n₁ material 320 of the number and size(s) desired for the particular faceplate. The number, size and spacing of the deposits n₁ correspond to the number, size and spacing of optical fibers in an equivalent taper of traditional optical fiber construction. The deposits n₁ are then cured, such as by exposure to UV light 325.
2. FIGS. 3F and 3G show one or more second dispensing heads 330 dispense n₂ material 335 in all the areas surrounding the deposits of n₁ material 320, within the established perimeter of the face of the taper, dispensed by the first dispensing heads in step 1. The n₂ material 335 is then cured, such as by exposure to UV light 325. FIG. 3G shows one layer of n₁ material 320 and n₂ material 335.
3. The process now repeats, layering upon the previous layers, with the next layer of n₁ material deposits and n₂ material fill directly on top of the previous layer. Each subsequent layer reducing in area and deposit size at the rate of taper desired. FIGS. 3H and 3I show four layers of n₁ material 320 and n₂ material 335 with the taper exaggerated for illustration.
4. The process is repeated until the desired final thickness D and taper is reached, shown in FIG. 3J. The completed Fiber Optic Taper 300 is then removed from the substrate 310. No polishing is needed on the surface or face 340 that was against the polished substrate surface of the substrate 310. Little or no polishing is needed on the top surface or face 345. No other cutting, finishing or machining operations are necessary.

The result is an array of tapered columns 350 of n₁ material surrounded by columns 355 of n₂ material. The ‘columns’ act as the ‘fibers’ do in a conventional fiber optics. The columns are in fact integrally-created fibers now ‘clad’ in n₂ material. The faceplate is simply ‘printed’ as described and is ready to use.

It can readily be seen that the method described herein is not restricted to square or rectangular face shapes. Fiber optic tapers of practically any face shape, including circular, elliptical, rectangular and square, can be created. Furthermore, this method allows the large face and small face to be of different shapes or aspect ratios, enabling fiber optic tapering functions such as anamorphic squeeze or other intentional geometric manipulation of the image.

Fiber Optic Taper, Method 2

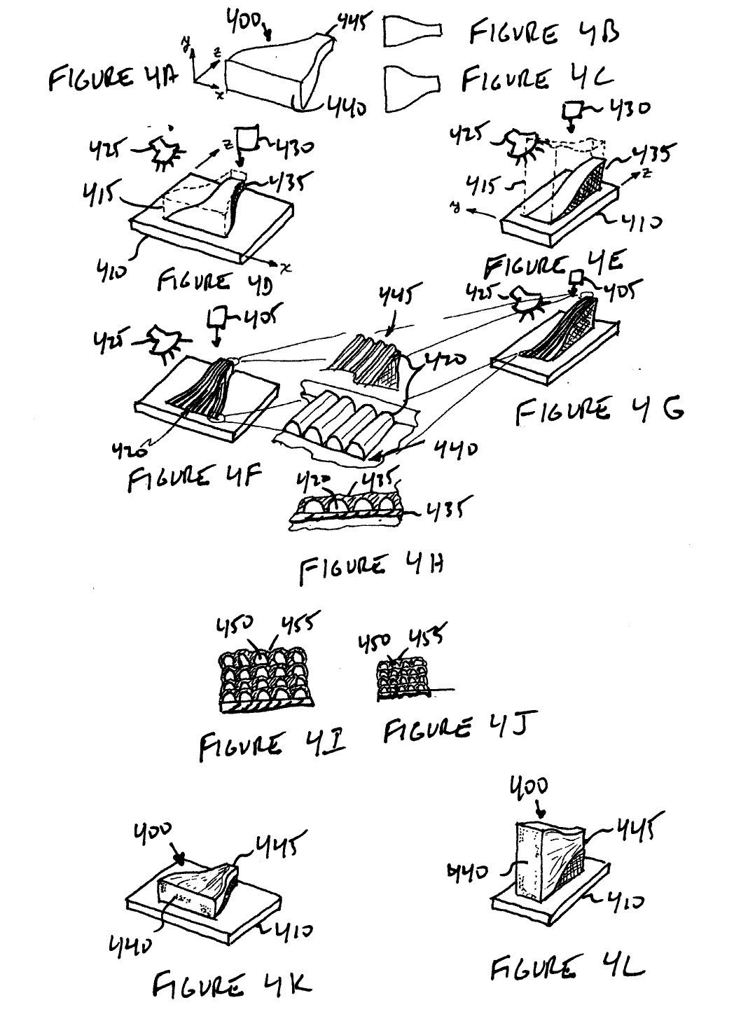

FIGS. 4A-4L show another embodiment of fabricating a Fiber Optic Taper 400, similar to Fiber Optic Taper 300, except in this method the fiber optic taper is created in cross-section, that is, in layers that are primarily perpendicular to the faces of the Taper. The layers can therefore be primarily oriented in the X-Z plane (FIG. 4D) or the Y-Z (FIG. 4E), whichever is deemed to be advantageous to the particular faceplate being fabricated.

The method is as follows:
1. An initial construct is created upon a polished substrate using one or more second dispensing heads 430 dispensing an initial layer of n₂ material 435, the size and shape 415 of which corresponds to the size and shape of one outer surface of the desired Taper in the chosen plane (FIGS. 4D and 4E). This construct is then cured, such as by exposure to UV light 425.
2. FIGS. 4F-4H show one or more first dispensing heads 405 dispensing continuous ‘strings’ or columns 450 from the large face to the small face of n₁ material 420 upon the cured layer of n₂ material 435. The dispensing rate or speed of dispensing is controlled as each string is dispensed, so that the cross sectional area of each string is made to reduce over its length from the large face to the small face, corresponding to the taper of the fibers in a conventional fiber optic taper. This material is then cured, such as by exposure to UV light 425.
3. More n₂ material 435 is then dispensed between and over the n₁ material 420 ‘strings’ created in step 2 forming columns 455. This material is then cured, such as by exposure to UV light 425. FIG. 4H shows one layer of n₁ material 420 and n₂ material 435 upon the initial n₂ material 435 in step 1.
4. The process now repeats, with each layer comprising a set of strings of n₁ material 420, cured, followed by a layer of n₂ fill 435, cured. FIGS. 4I and 4J show the large end 440 and small end 445 views of four layers of n₁ material 420 and n₂ material 435.
5. The process continues until the Taper is complete and thin layer of n₂ material 235 is dispensed as the final layer and cured, shown in FIGS. 4K and 4L.
6. The completed taper 400 is then removed from the substrate 410. Depending upon the application and level of optical quality desired, the faces 440, 445 of the completed taper may be optimized by grinding or sanding, and polishing.

An advantage of Fiber Optic Taper Method #2 over Fiber Optic Taper Method #1 is that each “fiber” is created by a continuous extrusion of n₁ material so that there are no ‘step’ or layer imperfections in the ‘fibers’ that might be present in Method #1.

It can readily be seen that the method described herein is not restricted to square or rectangular face shapes. Fiber optic tapers of practically any face shape, including circular, elliptical, rectangular and square, can be created. Furthermore, this method allows the large face and small face to be of different shapes or aspect ratios, enabling fiber optic tapering functions such as anamorphic squeeze or other intentional geometric manipulation of the image.

Other Fiber Optic Devices

It can readily be seen that the methods of the Invention are not limited to construction of fiber optic faceplates and fiber optic tapers. Indeed, practically any device historically constructed using conventional optical fibers can be constructed more efficiently and more cost effectively using the methods of the Invention.

Additionally, using the methods of the Invention, devices can now be constructed that would have been impossible or impractical using conventional optical fibers. An example of this is a device wherein a bend or curve is desired that is of too small of a radius for an optical fiber, but such limitation does not exist for a line or shape dispensed as a liquid and then cured.

Thus the limitations and shortcomings of the methods of producing the devices in the current art are overcome in the current invention, which provides significant novel improvements, including improvements in range of applications, versatility, manufacturability and cost-effectiveness.

It is intended that the specification and examples be considered as exemplary only, with a true scope and spirit of the invention being indicated by the following claims. In addition, where this application has listed the steps of a method or procedure in a specific order, it may be possible, or even expedient in certain circumstances, to change the order in which some steps are performed, and it is intended that the particular steps of the method or procedure claims set forth herebelow not be construed as being order-specific unless such order specificity is expressly stated in the claim.

The invention claimed is:

1. A method of fabricating an optical fiber-like device comprising depositing curable optical materials of differing indices of refraction in a controlled manner forming integral optical pathways, said pathways exhibiting total internal reflection and functioning as optical fibers.

2. The method of claim 1, wherein depositing curable optical materials in a controlled manner includes depositing multiple layers of discrete deposits of first and second curable optical materials between a bottom surface or face and a top surface or face forming integral optical pathways of the first material surrounded by the second material, the second material having a lower index of refraction than the first material.

3. The method of claim 2, wherein depositing multiple layers of discrete deposits of first and second curable optical materials includes depositing the first and second materials on the corresponding first and second material deposits of the previous layer.

4. The method of claim 2, wherein depositing multiple layers of discrete deposits of first and second curable optical materials includes curing each layer of first and second materials prior to depositing a subsequent layer.

5. The method of claim 2, wherein curing each layer of first and second materials includes exposure to UV light.

6. The method of claim 2, wherein depositing multiple layers of discrete deposits of first and second curable optical materials includes depositing the first and second materials using first and second dispensing heads.

7. The method of claim 6, wherein the first and second dispensing heads are the same head.

8. The method of claim 6, wherein the first and second dispensing heads are computer controlled.

9. The method of claim 2, wherein the device is tapered between the bottom and top surfaces or faces by reducing each subsequent layer in area and material deposit size at a rate of taper desired.

10. The method of claim 1, wherein the first and second materials are selected from the group consisting of polymer resins, acrylics(methacrylate), polycarbonates, epoxies, polyesters and urethanes.

11. A method of fabricating an optical fiber-like device by depositing multiple layers of curable optical materials of differing indices of refraction in a controlled manner on a polished surface of a substrate comprising:
creating a first layer of curable optical materials on the substrate by:
depositing an array pattern of discrete deposits of a first curable liquid optical material on the substrate using one or more first dispensing heads;
curing the first material;
depositing a second curable liquid optical material all the areas surrounding the discrete deposits of the first material on the substrate using one or more second dispensing heads, the second material having a lower index of refraction than the first material;
curing the second material;
creating subsequent layers of curable optical materials by:
depositing discrete deposits of a first curable liquid optical material on the discrete deposits of the previous layer using one or more first dispensing heads;
curing the first material;
depositing a second curable liquid optical material all the areas surrounding the discrete deposits of the first material using one or more second dispensing heads;
curing the second material; and
repeating the creating subsequent layers of the first and second materials on the previous layer until a desired thickness of the fiber optic device is reached, the last layer creating a top surface or face and the layers of discrete deposits forming integral optical pathways of the first material surrounded by the second material between the substrate and top surface or face.

12. The method of claim 11, wherein curing the first and second materials include exposure of the first and second materials to UV light.

13. The method of claim 11, wherein the first and second materials are selected from the group consisting of polymer resins, acrylics(methacrylate), polycarbonates, epoxies, polyesters and urethanes.

14. The method of claim 11, wherein the device is tapered between the substrate and top surface or face by reducing each subsequent layer in area and material deposit size at a rate of taper desired.

15. The method of claim 11, further comprising polishing the top surface or face.

16. A method of fabricating an optical fiber-like device by depositing multiple layers of curable optical materials of differing indices of refraction in a controlled manner on a polished surface of a substrate comprising:
creating an initial layer of curable optical material on the substrate by:
depositing an area of second material using one or more second dispensing heads that is equal to the size and shape of a cross-section of the desired optical fiber-like device, perpendicular to desired end faces of the device;
curing the second material;
creating a first layer of curable optical materials on the substrate by:
depositing multiple lines or columns of a first curable liquid optical material on the substrate using one or more first dispensing heads;
curing the first material;
depositing a second curable liquid optical material all the areas surrounding the line or column of the first material on the substrate using one or more second dispensing heads, the second material having a lower index of refraction than the first material;
curing the second material;
creating subsequent layers of curable optical materials by:
depositing multiple lines or columns a first curable liquid optical material on the previous layer using one or more first dispensing heads;
curing the first material;
depositing a second curable liquid optical material all the areas surrounding the lines or columns of the first material using one or more second dispensing heads;
curing the second material; and
repeating the creating subsequent layers of the first and second materials on the previous layer until a desired final height of the fiber optic device is reached, the line or columns of first materials forming integral optical pathways of the first material surrounded by the second material between the end faces.

17. The method of claim 16, wherein curing the first and second materials include exposure of the first and second materials to UV light.

18. The method of claim 16, wherein the first and second materials are selected from the group consisting of polymer resins, acrylics(methacrylate), polycarbonates, epoxies, polyesters and urethanes.

19. The method of claim 16, wherein the device is tapered between the end faces by reducing the cross sectional area of each column of first material to reduce over its length from a large surface or face to a small surface or face.

20. The method of claim 19, wherein an initial construct is created upon the substrate using one or more second dispensing heads dispensing the second material in a size and shape of which corresponds to the size and shape of one outer surface of the desired taper in a chosen plane.
